(19) United States
(12) Patent Application Publication
(10) Pub. No.: US 2005/0104035 A1
(43) Pub. Date: May 19, 2005

(54) Intelligent label for informing consumers of product quality criteria

(76) Inventors: Christopher Eaddy, Raleigh, NC (US); Todd Marshall, Wake Forest, NC (US); Bob Marshall, Franklinton, NC (US)

Correspondence Address: LITMAN LAW OFFICES, LTD., P.O. BOX 15035 CRYSTAL CITY STATION, ARLINGTON, VA, 22215, US

(21) Appl. No.: 10/705,829

(22) Filed: Nov. 13, 2003

(51) Int. Cl. C09K 19/00

(52) U.S. Cl. 252/299.01

(57) ABSTRACT

An intelligent label that informs consumers of product quality criteria. The intelligent label includes message indicators that reversibly or irreversibly change color and exhibit a large hysteresis characteristic in response to a temperature change. The message indicators are selected from the group consisting of product quality messages, medical messages, emergency messages, spiritual messages, joke messages, health messages, warning messages, trivia messages, astrological messages, riddle messages, cartoon indicators, and symbol indicators.

### BACKGROUND OF THE INVENTION

1. Field of the Invention

The present invention generally relates to labels and, more particularly, to an intelligent label that informs consumers of product quality criteria.

2. Description of the Related Art

Product labels provide a variety of static information regarding products carried in a container on which a corresponding product label is attached. Such static information is useful for informing users about details regarding the particular product, such as nutritional data, time expiration data, weight data, etc. However, such labels are unable to provide users with dynamic, real-time data regarding an associated product, such as the temperature, the effectiveness, etc.

Labels typically include a layer of face or face stock material backed by a layer of pressure-sensitive adhesive which in turn is covered by a release liner or carrier. The liner or carrier protects the adhesive during shipment and storage. The liner or carrier also allows for efficient handling of an array of individual labels after the labels are die-cut from the layer of face stock material and up to the point where the individual labels are dispensed in sequence on a labeling line.

A need exists for an intelligent label that informs product quality criteria to users. The related art is represented by the following references of interest.

U.S. Patent Application Publication No. 2001/0042262 A1, published on Nov. 22, 2001 for Victor Chu, describes a label for a product including an electronic display such as a liquid crystal display for displaying label information. The Chu application does not suggest an intelligent label for informing consumers of product quality criteria according to the claimed invention.

U.S. Patent Application Publication No. 2002/0124950 A1, published on Sep. 12, 2002, U.S. Pat. No. 5,868,892, issued on Feb. 9, 1999, and U.S. Pat. No. 5,997,964, issued on Dec. 7, 1999 for Walter Klima, Jr., describe a liquid crystal display and a method of making the same. The Klima, Jr. application and patents do not suggest an intelligent label for informing consumers of product quality criteria according to the claimed invention.

U.S. Patent Application Publication No. 2003/0017353 A1, published on Jan. 23, 2003, and European Patent Application Publication No. EP 1 260 955 A2, published on Nov. 27, 2002 for Takanari Yamaguchi et al., describe an indication label having excellent heat resistance and hydroscopic resistance. The Yamaguchi et al. applications do not suggest an intelligent label for informing consumers of product quality criteria according to the claimed invention.

U.S. Pat. No. 4,161,557, issued on Jul. 17, 1979 for Fred K. Suzuki et al., describes a polyvinyl butyral-liquid crystal film-forming composition and film. The Suzuki et al. patent does not suggest an intelligent label for informing consumers of product quality criteria according to the claimed invention.

U.S. Pat. No. 5,216,530, issued on Jun. 1, 1993 to Kenneth N. Pearlman et al., describes an encapsulated liquid crystal having a smectic phase. The Pearlman et al. patent does not suggest an intelligent label for informing consumers of product quality criteria according to the claimed invention.

U.S. Pat. No. 5,660,925, issued on Aug. 26, 1997 to Julian B. Cooley et al., describes a tamper indicating and authenticating label which provides a temporary visually perceptible indication that the label is authentic, and provides a permanent indication of tampering with the label. The Cooley et al. patent does not suggest an intelligent label for informing consumers of product quality criteria according to the claimed invention.

U.S. Pat. No. 5,895,704, issued on Apr. 20, 1999 to Rolf Lerch et al., describes an article for collecting and transporting a sample to be analyzed. The Lerch et al. patent does not suggest an intelligent label for informing consumers of product quality criteria according to the claimed invention.

U.S. Pat. No. 6,037,041, issued on Mar. 14, 2000 to Raymond J. L. Van Kooyk et al., describes a method of providing an encodable layer on a glass object and on the resultant product. The Kooyk et al. patent does not suggest an intelligent label for informing consumers of product quality criteria according to the claimed invention.

U.S. Pat. No. 6,214,250 B1, issued on Apr. 10, 2001 to Kyung H. Moh et al., describes a multilayer, temperature resistant, composite layer. The Moh et al. patent does not suggest an intelligent label for informing consumers of product quality criteria according to the claimed invention.

U.S. Pat. No. 6,217,966, issued on Apr. 17, 2001 to Wayne D. Finster et al., describes a label for an electronic price tag. The Finster et al. patent does not suggest an intelligent label for informing consumers of product quality criteria according to the claimed invention.

World Intellectual Property Organization (WIPO) Application Publication No. WO 99/05564, published on Feb. 4, 1999, describes a liquid crystal display and a label including a liquid crystal display. The WIPO application does not suggest an intelligent label for informing consumers of product quality criteria according to the claimed invention.

None of the above inventions and patents, taken either singly or in combination, is seen to describe the instant invention as claimed. Thus an intelligent label for informing consumers of product quality criteria solving the aforementioned problems is desired.

### SUMMARY OF THE INVENTION

The present invention is an intelligent label that informs consumers of product quality criteria. The intelligent label includes message indicators that reversibly or irreversibly change color and exhibit a large hysteresis characteristic in response to a temperature change. The message indicators are selected from the group consisting of product quality messages, medical messages, emergency messages, spiritual messages, joke messages, health messages, warning messages, trivia messages, astrological messages, riddle messages, cartoon indicators, and symbol indicators.

Accordingly, it is a principal aspect of the invention to provide an intelligent label for informing consumers of product quality criteria, the intelligent label including message indicators that reversibly or irreversibly change color and exhibit a large hysteresis characteristic in response to a temperature change, wherein the message indicators are selected from the group consisting of product quality messages, medical messages, emergency messages, spiritual messages, joke messages, health messages, warning messages, trivia messages, astrological messages, riddle messages, cartoon indicators, and symbol indicators.

It is another aspect of the invention to provide an intelligent label for informing consumers of product quality criteria, the intelligent label including message indicators including liquid crystals that reversibly or irreversibly change color and exhibit a large hysteresis characteristic in response to a temperature change, wherein the message indicators are selected from the group consisting of product quality messages, medical messages, emergency messages, spiritual messages, joke messages, health messages, warning messages, trivia messages, astrological messages, riddle messages, cartoon indicators, and symbol indicators.

It is a further aspect of the invention to provide an intelligent label for informing consumers of product quality criteria, the intelligent label including message indicators including thermochromic (or thermochromatic) material that reversibly or irreversibly change color and exhibit a large hysteresis characteristic in response to a temperature change, wherein the message indicators are selected from the group consisting of product quality messages, medical messages, emergency messages, spiritual messages, joke messages, health messages, warning messages, trivia messages, astrological messages, riddle messages, cartoon indicators, and symbol indicators.

It is an aspect of the invention to provide improved elements and arrangements thereof in an intelligent label for informing consumers of product quality criteria for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a front perspective view of a bottle with message indicators according to the invention.

FIG. 2 is a front perspective view of a beer/soda can with message indicators according to the invention.

FIG. 3 is a front perspective view of a two liter soda plastic bottle with message indicators according to the invention.

FIG. 4 is a front perspective view of a poultry container with message indicators according to the invention.

FIG. 5 is a front perspective view of a wine bottle with message indicators according to the invention.

FIG. 6 is a front perspective view of a tablet prescription/non-prescription container with message indicators according to the invention.

FIG. 7 is a front perspective view of a liquid presription/non-prescription container with message indicators according to the invention.

FIG. 8 is a block diagram of different types of messages/indicators that may be provided according to the present invention.

Similar reference characters denote corresponding features consistently throughout the attached drawings.

### DETAILED DESCRIPTION OF THE PREFERRED EMBODIMENTS

The present invention is an intelligent label that informs product quality criteria to users. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

The present invention is an intelligent label that informs product quality criteria to users of the label. The intelligent label includes message indicators that reversibly or irreversibly change color and exhibit a large hysteresis characteristic in response to a temperature change. The message indicators are selected from the group consisting of product quality messages, medical messages, emergency messages, spiritual messages, joke messages, health messages, warning messages, trivia messages, astrological messages, riddle messages, cartoon indicators, and symbol indicators.

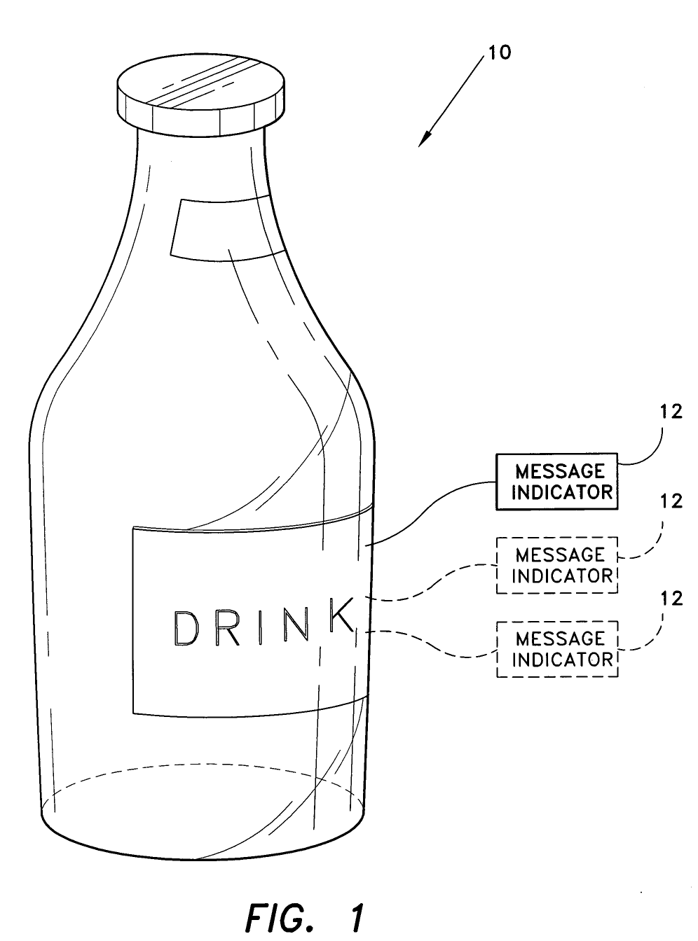

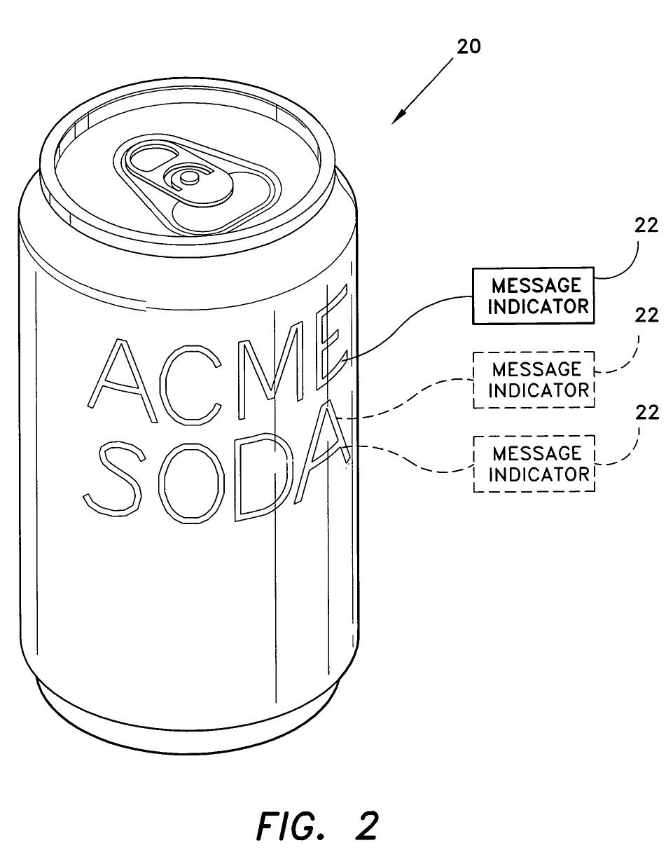

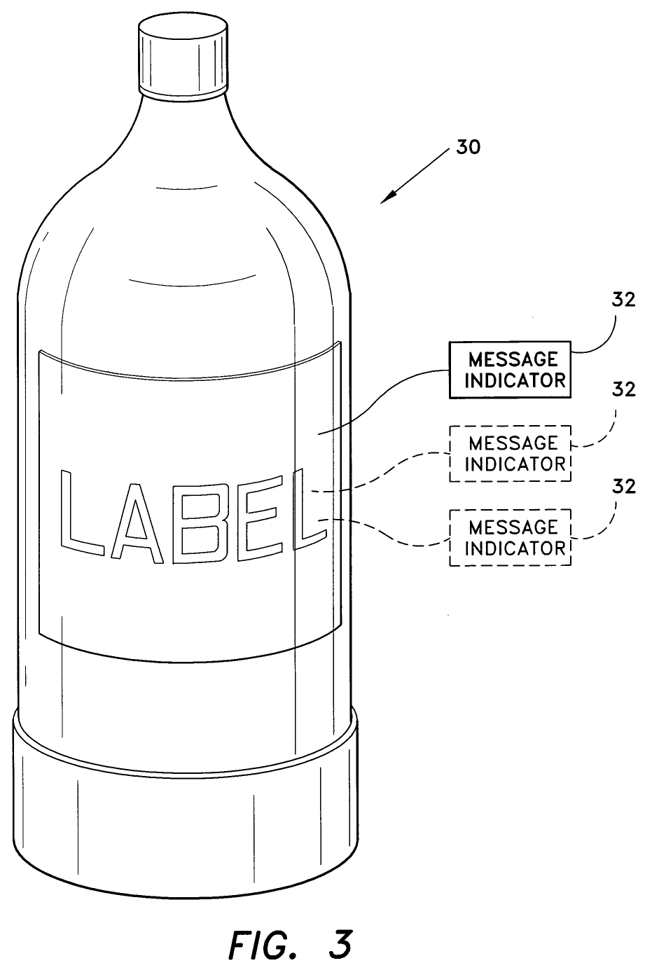

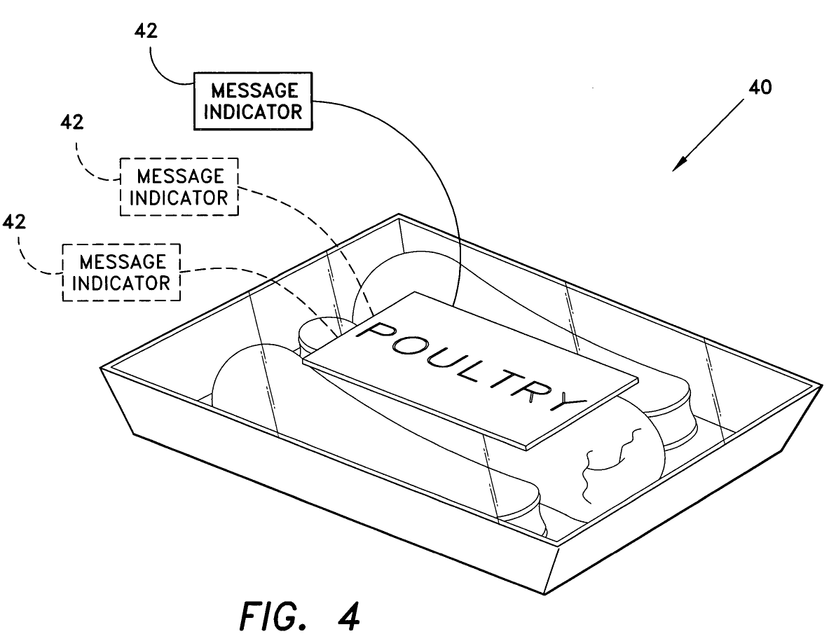

Referring to the drawings, FIG. 1 shows a bottle 10 for a liquid refreshment. The bottle 10 has an intelligent label according to the invention that includes message indicators 12. A beer/soda can 20 with an intelligent label including message indicators 22 is shown in FIG. 2. A two liter soda plastic bottle 30 with an intelligent label including message indicators 32 is shown in FIG. 3. A poultry container 40 with an intelligent label including message indicators 42 is shown in FIG. 4.

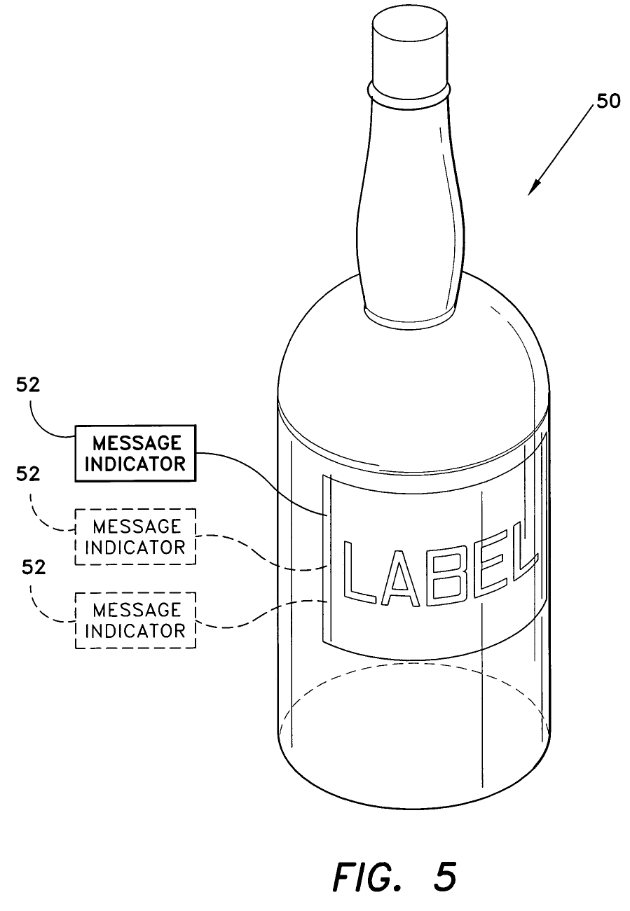

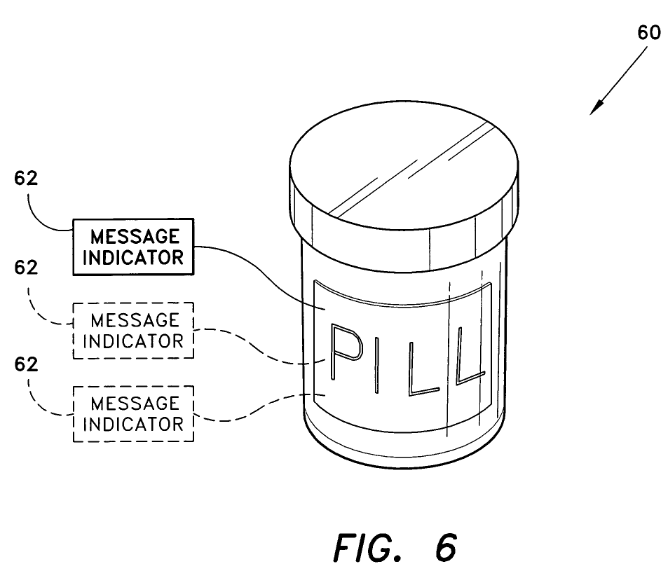

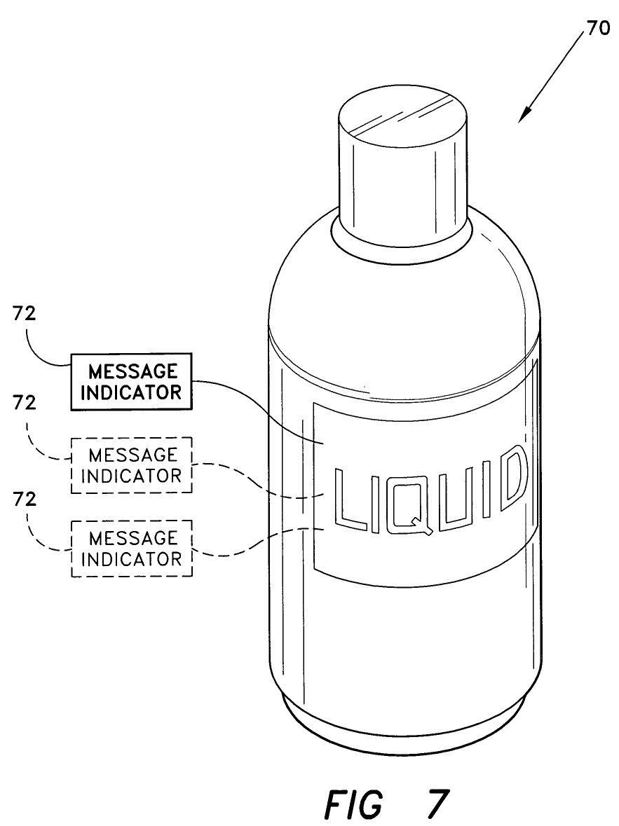

A wine bottle 50 with an intelligent lable including message indicators 52 is shown in FIG. 5. A tablet prescription/non-prescription container 60 with an intelligent label including message indicators 62 is shown in FIG. 6. A liquid prescription/non-prescription container 70 with an intelligent label including message indicators 72 is shown in FIG. 7. The messages indicators 12, 22, 32, 42, 52, 62, and 72 may be included on any label for any container.

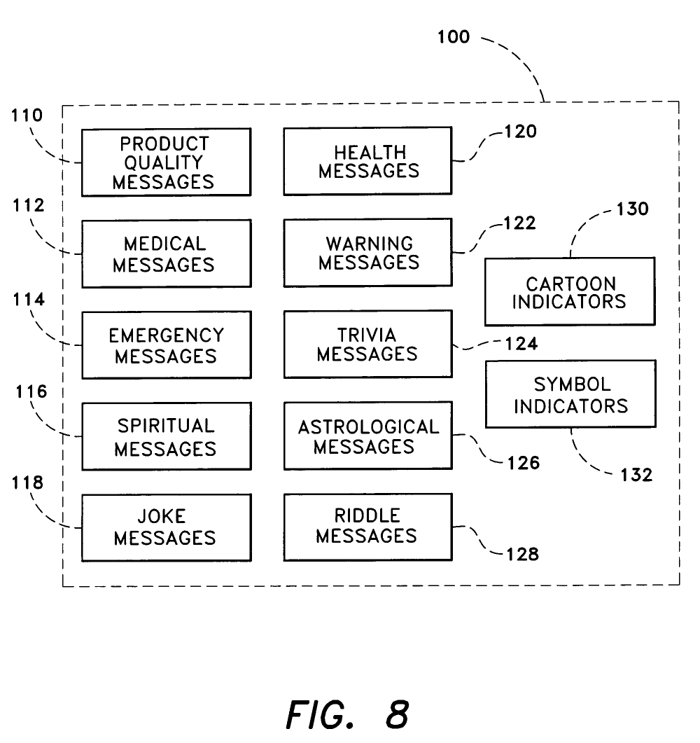

FIG. 8 illustrates a message indicator 100 showing the types of messages/symbols that may be associated with the message indicators 12, 22, 32, 42, 52, 62, and 72. As shown, the types of messages/symbols may include product quality messages 110, medical messages 112, emergency messages 114, spiritual messages 116, joke messages 118, health messages 120, warning messages 122, trivia messages 124, astrological messages 126, riddle messages 128, cartoon indicators 130, and symbol indicators 132.

The product quality messages 110 include phrases that indicate the quality of the product to which a label carrying the product quality messages is attached, such as POOR, FAIR, GOOD, EXCELLENT, etc., and that reversibly or irreveribly appear at different associated temperatures. The medical messages 112 include phrases that indicate medical criteria associated with the product to which a label carrying the medical messages is attached, such as MEDICALLY SAFE, MEDICALLY UNSAFE, etc., and that reversibly or irreversibly appear at different associated temperatures. For example, an irreversible medical message 112 may occur when a predetermined temperature has been reached, such as MAXIMUM TEMPERATURE EXCEEDED—DO NOT USE.

The emergency messages 114 include phrases that indicate emergency criteria associated with the product to which a label carrying the emergency messages is attached, such as NON-HAZARDOUS, HAZARDOUS, etc., and that reversibly or irreversibly appear at different associated temperatures. The spiritual messages 116 include phrases that indicate spiritual criteria associated with the product to which a label carrying the spiritual messages is attached, such as PRAISE THE LORD, GOD IS ON YOUR SIDE, etc., and that appear at different temperatures. The joke messages 118 include phrases that indicate random jokes that reversibly or irreversibly appear at different temperatures for entertainment purposes.

The health messages 120 include phrases that indicate health criteria associated with the product to which a label carrying the health messages is attached, and that reversibly or irreversibly appear at different associated temperatures. The warning messages 122 include phrases that indicate particular warnings at different associated temperatures. The trivia messages 124 include phrases that indicate trivia that reversibly or irreversibly appear at different messages at different temperatures for entertainment purposes. The astrological messages 126 include astrological messages that reversibly or irreversibly appear at different temperatures for entertainment purposes.

The riddle messages 128 include random riddles that reversibly or irreversibly appear at different temperatures for entertainment purposes. The cartoon indicators 130 include cartoons that reversibly or irreversibly appear at different temperatures in the form of cartoons, such as a bird for cool, a lion for hot, etc. The symbol indicators 132 include symbols that indicate product criteria in the form of symbols, such as the color red for hot, the color blue for cold, etc., and that reversibly or irreversibly appear at different associated temperatures.

The message indicators are formed using liquid crystals or thermochromic (or thermochromatic) material that reversibly or irreversibly change color and exhibit a large hysteresis characteristic in response to a temperature change. The message indicators include an electron-supplying organic coloring compound, an electron-accepting compound, and an ester compound for causing the hysteresis characteristic.

Electron-supplying organic coloring compounds include diaryl phthalides, indolyl phthalides, polyaryl carbinols, leuco auramines, acyl auramines, aryl auramines, rhodamine B lactams, indolines, spiropyrans and fluorans. Electron-accepting compounds include phenolic compounds, metal salts of the phenolic compounds, aromatic carboxylic acids, aliphatic carboxylic acids, metal salts of the acidic phosphoric esters, metal salts of the acidic phosphoric esters and triazole compounds. Ester compounds include alkyl esters, aryl esters and cycloalkyl esters of aromatic carboxylic acid having substitent(s) or not in the aromatic ring, branched alkyl esters, aryl esters, aryl alkyl esters and cycloalkyl esters of aliphatic carboxylic acid, alkyl esters of alicyclic carboxylic acid, diestels of dicarboxylic acid and glycerides.

Containers with labels including message indicators according to the invention enable customers to know the temperature of beverages they are about to drink and/or purchase. Such labels could also be applied to containers for frozen foods, fresh foods, and any refrigerated or perishable item, to reveal the temperature of the items. Labels including message indicators according to the invention enable users to know how long they may have before any food and/or medicine item would need to be returned to a frozen or refrigerated environment before higher temperatures would effect the contents and/or cause dangerous levels of bacteria. The messages indicators could also irreversibly change to a particular message/symbol when a predetermined temperature has been reached.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. An intelligent label for informing consumers of product quality criteria, said label comprising:
message indicators that change color and exhibit a large hysteresis characteristic in response to a temperature change,
wherein the message indicators are selected from the group consisting of product quality messages, medical messages, emergency messages, spiritual messages, joke messages, health messages, warning messages, trivia messages, astrological messages, riddle messages, cartoon indicators, and symbol indicators.

2. The intelligent label according to claim 1, wherein each message indicator comprises liquid crystals that reversibly change color and exhibit a large hysteresis characteristic in response to a temperature change.

3. The intelligent label according to claim 2, wherein the liquid crystals comprise an electron-supplying organic coloring compound, an electron-accepting compound, and an ester compound for causing the hysteresis characteristic.

4. The intelligent label according to claim 3, wherein the electron-supplying organic coloring compound is selected from the group consisting of diaryl phthalides, indolyl phthalides, polyaryl carbinols, leuco auramines, acyl auramines, aryl auramines, rhodamine B lactams, indolines, spiropyrans, and fluorans.

5. The intelligent label according to claim 3, wherein the electron-accepting compound is selected from the group consisting of phenolic compounds, metal salts of the phenolic compounds, aromatic carboxylic acids, aliphatic carboxylic acids, metal salts of the acidic phosphoric esters, metal salts of the acidic phosphoric esters, and triazole compounds.

6. The intelligent label according to claim 3, wherein the ester compound is selected from the group consisting of alkyl esters, aryl esters and cycloalkyl esters of aromatic carboxylic acid having substitent(s) or not in the aromatic ring, branched alkyl esters, aryl esters, aryl alkyl esters and cycloalkyl esters of aliphatic carboxylic acid, alkyl esters of alicyclic carboxylic acid, and diestels of dicarboxylic acid and glycerides.

7. The intelligent label according to claim 1, wherein each message indicator comprises liquid crystals that irreversibly change color and exhibit a large hysteresis characteristic in response to a temperature change.

8. The intelligent label according to claim 7, wherein the liquid crystals comprise an electron-supplying organic coloring compound, an electron-accepting compound, and an ester compound for causing the hysteresis characteristic.

9. The intelligent label according to claim 8, wherein the electron-supplying organic coloring compound is selected from the group consisting of diaryl phthalides, indolyl phthalides, polyaryl carbinols, leuco auramines, acyl auramines, aryl auramines, rhodamine B lactams, indolines, spiropyrans, and fluorans.

10. The intelligent label according to claim 8, wherein the electron-accepting compound is selected from the group consisting of phenolic compounds, metal salts of the phenolic compounds, aromatic carboxylic acids, aliphatic carboxylic acids, metal salts of the acidic phosphoric esters, metal salts of the acidic phosphoric esters, and triazole compounds.

11. The intelligent label according to claim 8, wherein the ester compound is selected from the group consisting of alkyl esters, aryl esters and cycloalkyl esters of aromatic carboxylic acid having substitent(s) or not in the aromatic ring, branched alkyl esters, aryl esters, aryl alkyl esters and cycloalkyl esters of aliphatic carboxylic acid, alkyl esters of alicyclic carboxylic acid, and diestels of dicarboxylic acid and glycerides.

12. The intelligent label according to claim 1, wherein each message indicator comprises thermochromic/thermochromatic material that reversibly changes color and exhibits a large hysteresis characteristic in response to a temperature change.

13. The intelligent label according to claim 12, wherein the thermochromic/thermochromatic material comprises an electron-supplying organic coloring compound, an electron-accepting compound, and an ester compound for causing the hysteresis characteristic.

14. The intelligent label according to claim 13, wherein the electron-supplying organic coloring compound is selected from the group consisting of diaryl phthalides, indolyl phthalides, polyaryl carbinols, leuco auramines, acyl auramines, aryl auramines, rhodamine B lactams, indolines, spiropyrans, and fluorans.

15. The intelligent label according to claim 13, wherein the electron-accepting compound is selected from the group consisting of phenolic compounds, metal salts of the phenolic compounds, aromatic carboxylic acids, aliphatic carboxylic acids, metal salts of the acidic phosphoric esters, metal salts of the acidic phosphoric esters, and triazole compounds.

16. The intelligent label according to claim 13, wherein the ester compound is selected from the group consisting of alkyl esters, aryl esters and cycloalkyl esters of aromatic carboxylic acid having substitent(s) or not in the aromatic ring, branched alkyl esters, aryl esters, aryl alkyl esters and cycloalkyl esters of aliphatic carboxylic acid, alkyl esters of alicyclic carboxylic acid, and diestels of dicarboxylic acid and glycerides.

17. The intelligent label according to claim 1, wherein each message indicator comprises thermochromic/thermochromatic material that irreversibly changes color and exhibits a large hysteresis characteristic in response to a temperature change.

18. The intelligent label according to claim 17, wherein the therochromic/thermochromatic material comprises an electron-supplying organic coloring compound, an electron-accepting compound, and an ester compound for causing the hysteresis characteristic.

19. The intelligent label according to claim 18, wherein the electron-supplying organic coloring compound is selected from the group consisting of diaryl phthalides, indolyl phthalides, polyaryl carbinols, leuco auramines, acyl auramines, aryl auramines, rhodamine B lactams, indolines, spiropyrans, and fluorans.

20. The intelligent label according to claim 18, wherein the electron-accepting compound is selected from the group consisting of phenolic compounds, metal salts of the phenolic compounds, aromatic carboxylic acids, aliphatic carboxylic acids, metal salts of the acidic phosphoric esters, metal salts of the acidic phosphoric esters, and triazole compounds.

21. The intelligent label according to claim 18, wherein the ester compound is selected from the group consisting of alkyl esters, aryl esters and cycloalkyl esters of aromatic carboxylic acid having substitent(s) or not in the aromatic ring, branched alkyl esters, aryl esters, aryl alkyl esters and cycloalkyl esters of aliphatic carboxylic acid, alkyl esters of alicyclic carboxylic acid, and diestels of dicarboxylic acid and glycerides.
